(19) United States
(12) Patent Application Publication
(10) Pub. No.: US 2025/0322292 A1
(43) Pub. Date: Oct. 16, 2025

(54) TRAINING AND USING AN EXTRACTION MACHINE LEARNING MODEL BASED ON PREDICTING ANNOTATION QUALITY

(71) Applicant: INTERNATIONAL BUSINESS MACHINES CORPORATION, ARMONK, NY (US)

(72) Inventors: Jyotsna Kasa, Visakhapatnam (IN); Rajesh M. Desai, San Jose, CA (US); Praveen Vyas, Bangalore (IN); Varul Jain, Bangalore (IN)

(21) Appl. No.: 18/633,992

(22) Filed: Apr. 12, 2024

(51) Int. Cl. G06N 20/00

(52) U.S. Cl. CPC G06N 20/00

(57) ABSTRACT

Provided are techniques for training and using an extraction machine learning model based on predicting annotation quality. A first overall quality score is generated for annotated documents. It is determined that the first overall quality score is below a quality threshold. A ranked list of annotated documents is generated for review. It is determined that one or more of the annotated documents in the ranked list of annotated documents have been updated. A second overall quality score is generated for the annotated documents. It is determined that the second overall quality score is above the quality threshold. An extraction machine learning model is trained with the annotated documents. The extraction machine learning model is used to extract data items from the annotated documents.

### BACKGROUND

Embodiments of the invention relate to training and using an extraction machine learning model based on predicting annotation quality with a hybrid technique.

Data annotation may be described as a process of annotating fields in a document and checking the annotations in that document. Precise annotated data is useful in building accurate machine learning models. An annotation may be described as additional information associated with the fields.

Currently, humans typically check the annotations. For example, a third party (instead of the data scientist who is to use the data) may perform the annotation check. The third party may perform the check based on an acceptance criteria in terms of error rate in the annotations. The third party may include multiple reviewers.

However, in a large, annotated dataset, it is impractical to go through every document and validate the annotations, and there is a diminishing return to check every annotation for correctness. In addition, identifying human errors and gaps in annotations may be time consuming and error-prone. Moreover, missing and invalid annotations in a dataset is of concern in training the machine learning model. Also, incorrect annotations may lead to a high bias/variance tradeoff complexity.

### SUMMARY

In accordance with certain embodiments, a computer-implemented method comprising operations is provided for training and using an extraction machine learning model based on predicting annotation quality. In such embodiments, a first overall quality score is generated for annotated documents. It is determined that the first overall quality score is below a quality threshold. A ranked list of annotated documents is generated for review. It is determined that one or more of the annotated documents in the ranked list of annotated documents have been updated. A second overall quality score is generated for the annotated documents. It is determined that the second overall quality score is above the quality threshold. An extraction machine learning model is trained with the annotated documents. The extraction machine learning model is used to extract data items from the annotated documents.

In accordance with other embodiments, a computer program product comprising a computer readable storage medium having program code embodied therewith is provided, where the program code is executable by at least one processor to perform operations for training and using an extraction machine learning model based on predicting annotation quality. In such embodiments, a first overall quality score is generated for annotated documents. It is determined that the first overall quality score is below a quality threshold. A ranked list of annotated documents is generated for review.

It is determined that one or more of the annotated documents in the ranked list of annotated documents have been updated. A second overall quality score is generated for the annotated documents. It is determined that the second overall quality score is above the quality threshold. An extraction machine learning model is trained with the annotated documents. The extraction machine learning model is used to extract data items from the annotated documents.

In accordance with yet other embodiments, a computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations for training and using an extraction machine learning model based on predicting annotation quality. In such embodiments, a first overall quality score is generated for annotated documents. It is determined that the first overall quality score is below a quality threshold. A ranked list of annotated documents is generated for review. It is determined that one or more of the annotated documents in the ranked list of annotated documents have been updated. A second overall quality score is generated for the annotated documents. It is determined that the second overall quality score is above the quality threshold. An extraction machine learning model is trained with the annotated documents. The extraction machine learning model is used to extract data items from the annotated documents.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment for an annotation system in accordance with certain embodiments.

FIG. 3 illustrates, in a flowchart, operations for refining annotations for documents in accordance with certain embodiments.

FIGS. 4A and 4B illustrate, in a flowchart, operations for processing the annotated documents in accordance with certain embodiments.

FIG. 5 illustrates, in a flowchart, operations for generating a ranked list of annotated documents with annotations for review in accordance with certain embodiments.

FIGS. 6A and 6B illustrate, in a flowchart, operations for training and using an extraction machine learning model based on predicting annotation quality in accordance with certain embodiments.

FIG. 7 illustrates an example screen for defining field labels in an ontology in accordance with certain embodiments.

FIG. 8 illustrates an example annotation quality review summary by document types for a base score technique in accordance with certain embodiments.

FIG. 9 illustrates an example annotation quality detail review summary by documents for a base score technique in accordance with certain embodiments.

FIG. 10 illustrates an example annotation quality detail review summary by extracted values for a base score technique in accordance with certain embodiments.

FIG. 11 illustrates an example annotation quality detail review summary by field names for a base score technique in accordance with certain embodiments.

FIG. 12 illustrates an example annotation quality detail review summary with percentage based annotation results for test documents for a base score technique in accordance with certain embodiments.

FIG. 13 illustrates an example of documents with different patterns in accordance with certain embodiments.

FIGS. 14A, 14B, and 14C illustrate various annotated documents with fields in accordance with certain embodiments.

FIG. 15 illustrates an average confidence and voting technique in accordance with certain embodiments.

FIG. 16 illustrates datasets and field label information in accordance with certain embodiments.

FIG. 17 illustrates ontology data for feature engineered models in accordance with certain embodiments.

FIG. 18 illustrates processing by feature engineered models in accordance with certain embodiments.

FIG. 19 illustrates an example review for document anomalies in accordance with certain embodiments.

FIG. 20 illustrates an example screen for annotation review in accordance with certain embodiments.

FIG. 21 illustrates an example screen for error analysis in accordance with certain embodiments.

FIG. 22 illustrates an example screen of an anomaly in accordance with certain embodiments.

FIG. 23 illustrates an example screen of another anomaly in accordance with certain embodiments.

FIG. 24 illustrates processing of a dataset in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

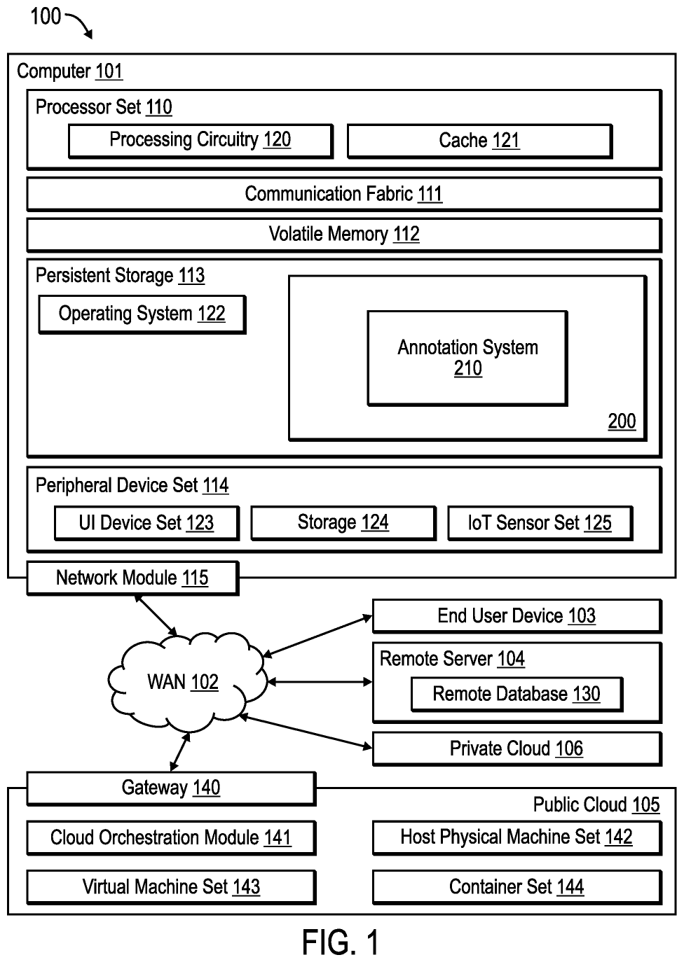

Computing environment 100 of FIG. 1 contains an example of an environment for the execution of at least some of the computer code involved in performing the inventive methods, such as an annotation system 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

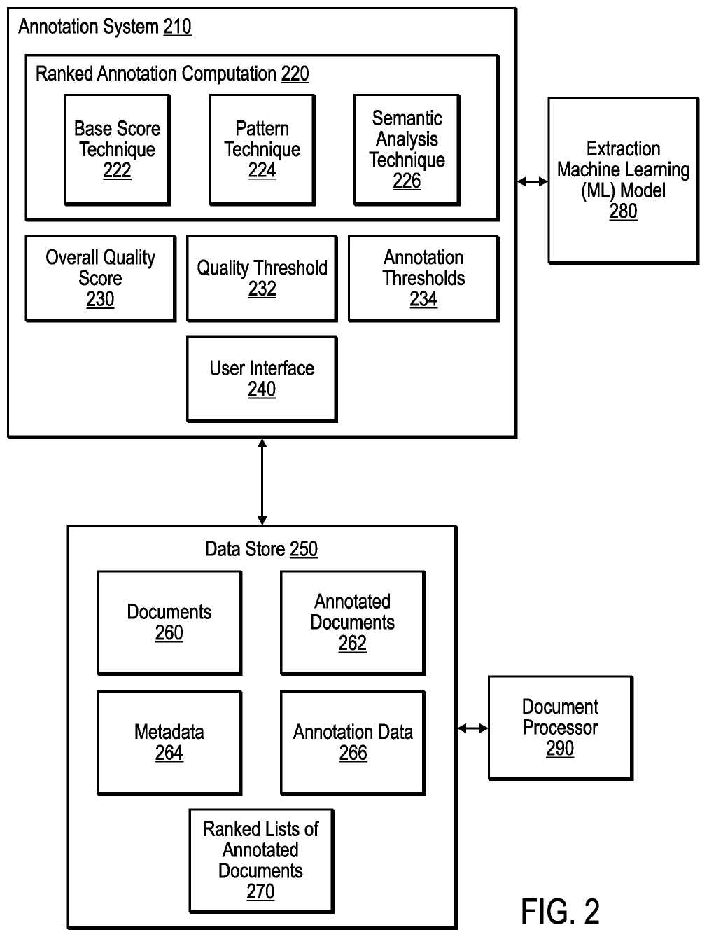

FIG. 2 illustrates a computing environment for an annotation system 210 in accordance with certain embodiments. The annotation system 210 is connected to a data store 250 and to an extraction Machine Learning (ML) model 280.

The annotation system 210 includes a ranked annotation computation 220. In certain embodiments, the ranked annotation computation 220 performs a base score technique 222, a pattern technique 224, and/or a semantic analysis technique 226. The annotation system 210 includes an overall quality score 230, a quality threshold 232, and annotation thresholds 234. Moreover, the annotation system 210 provides a user interface 240 (e.g., a Graphical User Interface (GUI)).

The data store 250 includes documents 260, annotated documents 262 (which are the documents 260 with annotations), metadata 264 (e.g., classes and fields of the annotated documents 262), annotation data 266 (e.g., intermediate states of the annotated documents 262 and various statistics), and ranked lists of annotated documents 270.

In certain embodiments, the annotated documents 262 include a training dataset (with documents for training the extraction ML model 280), a testing dataset (with documents for testing the extraction ML model 280), and a validation dataset (with documents for validating the extraction ML model 280). In certain embodiments, the testing dataset (also referred to as a “test dataset”) includes a blind dataset. In certain embodiments, for the blind dataset, annotations may not be available, and, if annotations are available, the blind dataset document may not be annotated under a specific document class.

In certain embodiments, a document processor 290 is connected to the data store 250. The document processor 290 may annotate the documents 260 to generate the annotated documents 262, the metadata 264, and annotation data 266.

In certain embodiments, the annotation system 210 performs ranked annotation computation 220 to generate a ranked list of annotated documents 270, which includes the ranked, annotated documents with confidence scores. In certain embodiments, a confidence score for an annotated document 262 indicates how accurate the annotations are for that annotated document 262. In certain embodiments, the annotated documents are ranked from a lowest confidence score (e.g., lowest quality) to a highest confidence score (e.g., highest quality). That is, with embodiments, annotated documents with lower confidence scores are listed before annotated documents with higher confidence scores.

In certain embodiments, the ranked annotation computation 220 performs any combination of the following techniques: a base score technique 222, a pattern technique 224, and a semantic analysis technique 226. In certain embodiments, indicators are set to indicate which of the techniques 222, 224, 226 is to be used and in which order.

In certain embodiments, the base score technique 222 (i.e., a first technique) may be described as a field type/value analysis technique or a random sampling (field error) technique. In certain embodiments, the pattern technique 224 (i.e., a second technique) may be described as a template based technique (anomaly pattern detection) or a technique for identifying accidental user errors. In certain embodiments, the semantic analysis technique 226 (i.e., a third technique) may be described as a clustering technique using feature engineering model processing.

In certain embodiments, the first technique 222, 224, 226 generates a ranked list of annotated documents 270, and each other technique 222, 224, 226 updates that ranked list of annotated documents 270. In certain embodiments, each of the techniques 222, 224, 226 generates a ranked list of annotated documents 270, which are later combined. The annotation system 210 may provide the ranked list of annotated documents 270 via the user interface 240.

In certain embodiments, the quality score 230 is configurable (e.g., may be adjusted by a data scientist). If an overall quality score 230 for a set of annotated documents 262 exceeds a quality threshold 232 (e.g., set by a data scientist), the annotation system 210 uses the set of annotated documents 262 to train the extraction ML model 280. Then, the annotation system 210 uses the extraction ML model 280 to extract data from documents.

In certain embodiments, the overall quality score 230 may be calculated using an unsupervised quality score computation or a supervised quality score computation.

In certain embodiments, each technique 222, 224, 226 has an associated annotation threshold 234 for use in identifying annotated documents 262 that should be reviewed. The annotation threshold 234 may be the same or different for different techniques 222, 224, 226. In certain embodiments, for each of the techniques 222, 224, 226, a confidence score associated with an annotated document is compared to a corresponding annotation threshold 234. If the confidence score is equal to or below the annotation threshold (i.e., the confidence score indicates a low quality of the annotations in the annotated document), then the annotated document is included for review (e.g., via the user interface 240). If the confidence score is greater than the annotation threshold (i.e., the confidence score indicates a high quality of the annotations in the annotated document), then the annotated document is not included for review. These annotated documents with lower confidence scores may be referred to as the highest priority annotated documents that should be reviewed by a user (e.g., a data scientist) so that annotations may be updated and improved. In addition, the ranked list of annotated documents 270 includes the annotated documents ordered based on the confidence scores, going from lower confidence score to higher confidence score.

In certain embodiments, the base score technique 222 uses both positional average and field label average, and this information is also used by the pattern technique 224 to find the average confidence for related patterns based on an annotation threshold to satisfy the confidence score. In certain embodiments, the base score technique 222 uses the field label average percentage and uses text (extracted via Optical Character Recognition (OCR)) as an input and provides a confidence score indicating whether the text belongs to the correct field label. Then, the field label average score may be used by the semantic analysis technique 226 along with the sematic analysis score to determine whether the confidence score indicating whether the text belongs to the correct field label is correct.

Data extraction from documents may be described as a two-operation process of: classification (i.e., identifying classes that define field scope) and extraction (i.e., data extraction for fields defined in the document classes). The annotation system 210 enables improving the annotations in the annotated documents 262 to provide high quality annotations for initially training the data extraction ML model 280 and later fine tuning the data extraction ML model 280.

Initially, a user configures an ontology, which involves creation of a document class with a set of default and/or required fields with various field settings (e.g., mandatory, data type, aliases, etc.) that are used to extract the data points, field values, and key-value pairs from the annotated document 262. An ontology may be described as domain specific document classes with field definitions that are to be extracted from the annotated documents 262 for a given use case. For example, an invoice document class may have Invoice Number, Invoice Total, and Invoice Date as fields to extract for an automated invoice processing application (i.e., the given use case). If the objective is to extract these fields, the domain specific documents may be made available to (e.g., uploaded to the data store 250) the annotation system 210. These domain specific documents may be annotated for the different fields (key value pairs) and mapped to the respective pre-defined fields (key-classes) existing for the document class.

The annotation system 210 evaluates the quality of the annotated documents 262 with reference to the overall quality score 230 before training the extraction ML model 280 to identifier anomalies (e.g., outliers) that are often missed with conventional techniques. With this evaluation, after training the extraction ML model 280 with the annotated documents 262, the annotation system 210 avoids having the extraction ML model 280 become overfit/underfit and avoids having the bias/variance trade off complexity being high. The bias/variance trade off describes the relationship between the complexity of the extraction ML model 280, the accuracy of predictions by the extraction ML model 280, and how well the extraction ML model 280 is able to make predictions on previously unseen data that were not used to train the extraction ML model 280.

In certain embodiments, the annotation system 210 determines the overall quality score 230 of the annotations in the annotated documents 262 before training the extraction ML model 280. If the overall quality score 230 is equal to or less than (below) the quality threshold, the annotation system 210 does not train the extraction ML model 280 with the annotated documents 262. Instead, with a feedback loop, the annotation system 210 enables a user to review the lowest quality annotations (i.e., those having the lower confidence scores) and update those annotations to improve the quality of the annotations. Then, the annotation system 210 determines the overall quality score 230 again. Once the overall quality score 230 is higher than (above) the quality threshold 232, the annotation system 210 uses the annotated documents 262 to train the extraction ML model 280. In this manner, the annotation system 210 uses the overall quality score to determine when the annotated documents 262 may be used to train the extraction ML model 280.

In addition, because the annotation system 210 provides the ranked list of annotated documents 270, rather than having a user review the entire dataset of annotated documents 262, the annotation system 210 enables the user to review the annotated documents having lower confidence scores (with reference to an annotation threshold) in the ranked list of annotated documents 270.

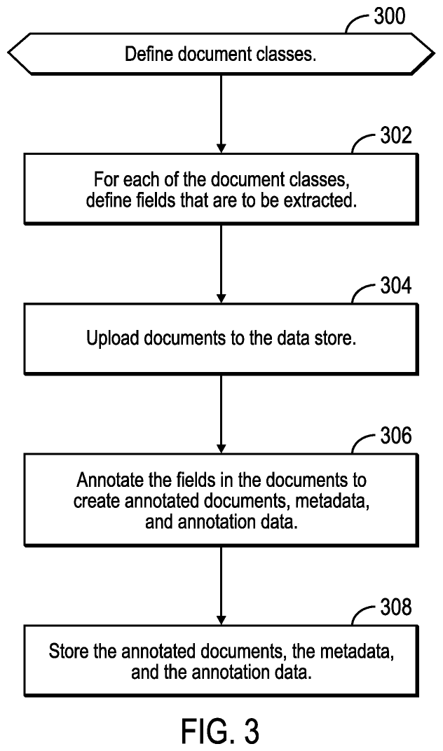

FIG. 3 illustrates, in a flowchart, operations for refining annotations for documents 260 in accordance with certain embodiments. Control begins at block 300 with a user (e.g., a data scientist for a particular use case) defining document classes. In block 302, for each of the document classes, the user defines fields that are to be extracted from the documents 260. In certain embodiments, the classes and fields are defined in an ontology. In block 304, the user uploads the documents 260 to the data store 250. In block 306, the user annotates the fields in the documents 260 to create the annotated documents 262, metadata 264, and annotation data 266. In block 308, the user stores the annotated documents 262, the metadata 264, and the annotation data 266 in the data store 250. In certain embodiments, the document processor 290 stores the annotation data 266 for each annotated document 264 in a database by document class.

In certain embodiments, a field is a document class level concept (e.g., Invoice, Invoice Number, and Invoice Date are fields), and a field label is an instance of one of these fields annotated for a given document.

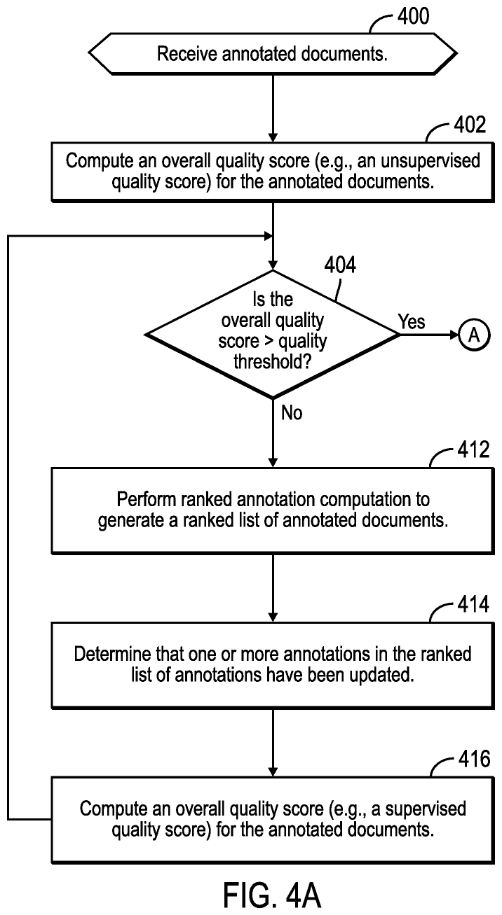

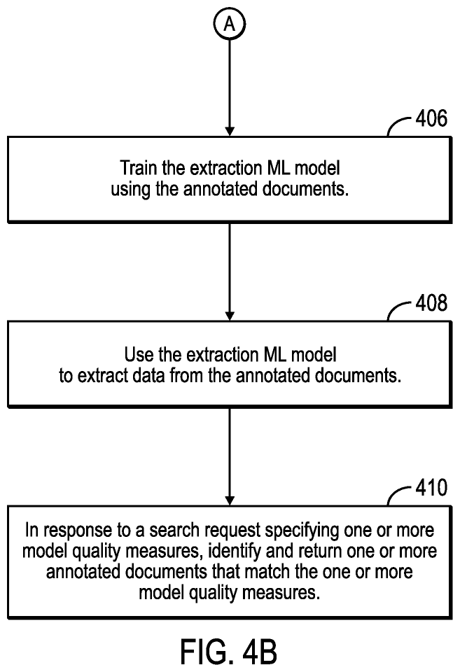

FIGS. 4A and 4B illustrate, in a flowchart, operations for processing the annotated documents in accordance with certain embodiments. Control begins at block 400 with the annotation system 210 receiving the annotated documents 262. In block 402, the annotation system 210 computes an overall quality score 230 (e.g., an unsupervised quality score) for the annotated documents 262. In certain embodiments, the annotation system 210 computes the overall quality score in block 402 based on the similarity of annotations across documents for the same field. For example, if the annotations share the same features, then the field receives a higher confidence score, while, if the annotations are dissimilar, then the field gets a lower confidence score (i.e., may be an outlier field). In block 404, the annotation system 210 determines whether the overall quality score 230 is greater than the quality threshold 232. If the overall quality score 230 is greater than the quality threshold 232, processing continues to block 406 (FIG. 4B), and, if the overall quality score 230 is less than or equal to the quality threshold 232, processing continues to block 412 (FIG. 4A).

In block 406, the annotation system 210 trains the extraction ML model 280 using the annotated documents 262. In certain embodiments, a data scientist may initiate the training. In block 408, the annotation system 210 uses the extraction ML model 280 to extract data from the annotated documents 262. In certain embodiments, the content extraction includes extracting values from fields (key-value pairs), tabular data, check boxes, signatures, barcodes, stamps, Quick Response (QR) codes, etc.

In block 410, the annotation system 210, in response to a search request specifying one or more model quality measures, identifies and returns one or more annotated documents that match the one or more model quality measures. In certain embodiments, the model quality measures are based on the testing dataset or the blind dataset (which is a subset of the testing dataset). In certain embodiments, the model quality measures include any combination of: accuracy, F1 score (a measure of predictive performance), precision, recall, etc. on the dataset of annotated documents 262. In certain embodiments, the annotation system 210 stores the model quality measures in a database and issues the search request against the database to identify and return the one or more annotated documents.

In block 412, the annotation system 210 performs ranked annotation computation to generate a ranked list of annotated documents 270 for review. In certain embodiments, this is an iterative process to compute the ranked list of annotated documents 270 from lowest to highest in each batch of annotated documents 262. In certain embodiments, the batch may be defined by a data scientist and refers to a group of annotated documents 262.

In block 414, the annotation system 210 determines that one or more annotations in the ranked list of annotated documents 270 have been updated. In certain embodiments, the annotation system 210 receives an indication (e.g., from the document processor 290 or from a user) that one or more annotations have been updated, and the determination is based on this indication.

In block 416, the annotation system 210 computes the overall quality score (e.g., a supervised quality score) for the annotated documents 262. In certain embodiments, the supervised quality score computation (QSC)=(% of annotations reviewed−% of annotations corrected). That is, the supervised quality score computation looks at the percentage of annotations that were reviewed by a user and the percentage of those annotations that were corrected. With embodiments, the larger the review set of annotations, the higher the confidence. From block 416, processing continues to block 404.

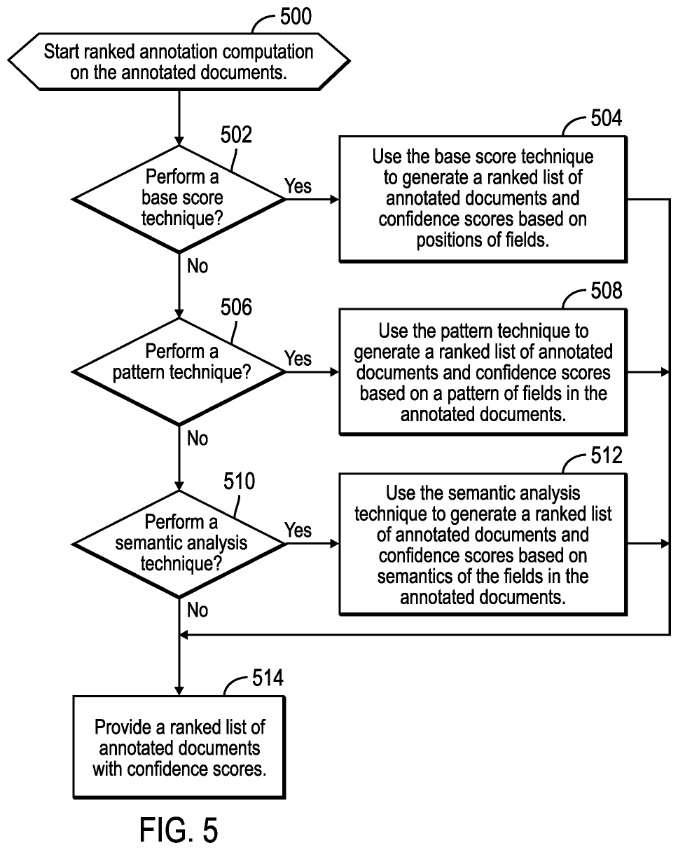

FIG. 5 illustrates, in a flowchart, operations for generating a ranked list of annotated documents 270 with annotations for review in accordance with certain embodiments. Control begins at block 500 with the annotation system 210 starting ranked annotation computation on the annotated documents 262.

In block 502, the annotation system 210 determines whether the base score technique is to be performed. If so, processing continues to block 504, otherwise, processing continues to block 506.

In block 504, the annotation system 210 uses the base score technique to generate a ranked list of annotated documents 270 and confidence scores based on positions of fields. In certain embodiments, the base score technique generates a ranked list of annotated documents 270 based on the confidence scores of positions of fields in the annotated documents. For example, if a particular field is often in a right, upper portion of an annotated document, then annotated documents having the field in that position have higher confidence scores than annotated documents having that field in other positions (e.g., in a left, lower portion of the annotated document). From block 504, processing continues to block 514.

In block 506, the annotation system 210 determines whether the pattern technique is to be performed. If so, processing continues to block 508, otherwise, processing continues to block 510.

In block 508, the annotation system 210 uses the pattern technique to generate a ranked list of annotated documents 270 and confidence scores based on a pattern of fields in the annotated documents. In certain embodiments, the pattern technique generates a ranked list of annotated documents 270 based on the confidence scores of patterns of fields in the annotated documents. For example, if most annotated documents have a pattern of four fields in particular positions then those annotated documents have higher confidence scores than a new, annotated document that has three of the four fields. As another example, for an invoice, the annotation system 210 may expect that the Invoice Number, the Invoice Date, the Due Date, the Vendor Name/Address, and the Send to Name/Address fields will be at the top of the annotated document (i.e., the start of the annotated document) and may expect that the Invoice Total, the Subtotal, and the Payment Due fields will be at the bottom of the annotated document, and the annotation system 210 identifies this as a pattern that is checked across annotated documents and used to generate confidence scores for each of those annotated documents. In certain embodiments, generating the ranked list of annotated documents 270 based on the pattern of fields involves updating the ranked list of annotated documents 270 generated using another technique (e.g., updating the ranked list of annotated documents 270 based on the base score technique) by adjusting the confidence scores of the annotated documents, which may change the ranking order of the annotated documents. From block 508, processing continues to block 514.

In block 510, the annotation system 210 determines whether the semantic analysis technique is to be performed. If so, processing continues to block 512, otherwise, processing continues to block 514.

In block 512, the annotation system 210 uses the semantic analysis technique to generate a ranked list of annotated documents 270 and confidence scores based on semantics of the fields in the annotated documents. In certain embodiments, the semantic analysis technique generates a ranked list of annotated documents 270 based on the confidence scores of semantic analysis of fields in the annotated documents. That is, the semantic analysis technique looks for value consistency across different annotated documents for the same field annotations. For example, if a field in an annotated document is expected to have a date and is annotated as Payment Due, then the annotated document has a lower confidence score. In certain embodiments, generating the ranked list of annotated documents 270 based on the semantics of the fields involves updating the ranked list of annotated documents 270 generated using another technique (e.g., updating the ranked list of annotated documents 270 based on the pattern of fields) by adjusting the confidence scores of the annotated documents, which may change the ranking order of the annotated documents. From block 512, processing continues to block 514.

In block 514, the annotation system 210 provides the ranked list of annotated documents 270 with confidence scores. That is, the ranked list of annotated documents 270 includes the annotated documents ordered based on the confidence scores, going from lower confidence score to higher confidence score. The annotation system 210 may provide the ranked list of annotated documents 270 along with the confidence scores using the user interface 240.

In certain embodiments, the confidence scores are used for the ranking. If multiple, annotated documents have a same confidence score, the annotation system 210 may rank them based on various techniques (e.g., the annotated document from the base score technique is listed before another annotated document from the pattern technique, which is before another annotated document from the semantic analysis technique).

In certain embodiments, one of the techniques is set as a default technique (e.g., by a data scientist identifying the default technique) that is performed if no ranked list of annotated documents 270 has been generated before block 514. In certain embodiments, the annotation system 210 provides the ranked list of annotated documents 270 via the user interface 240, where selection of an annotated document displays that annotated document adjacent to the ranked list of annotated documents 270.

In certain embodiments, the annotation system 210 performs three phases. In a first phase, the annotation system 210 obtains a positional average for annotations. The annotation system 210 determines the average score of a series of observations of a particular annotated field. Also, the annotation system 210 determines accidental user errors using clustering and ML based classifiers. Moreover, the annotation system 210 performs variance detection and ranks anomalies (i.e., fields that are not in expected positions) as high in priority (i.e., having a confidence score equal to or below an annotation threshold) for review, while ranking consistent annotations for a field as low in priority (i.e., having a confidence score above the annotation threshold) for review.

In a second phase, the annotation system 210 performs pattern detection to build confidence on annotations. In certain embodiments, in the first phase, the annotation system 210 uses a linear mechanism, while in the second phase, the annotation system 210 uses an average area and an annotation threshold for annotated fields in documents. In addition, the annotation system 210 identifies anomalies in the annotations using patterns.

In a third phase, the annotation system 210 identifies semantic annotation errors using feature engineered models. The following example that an email ID expects a type of string (e.g., with special characters), while a Feature expects another type of string (e.g., with no special characters):
Feature→Email ID—data is from a string with text written as data.xyz123@company.com (i.e., contains a set of running characters contains alphanumeric as well as special characters ‘@’ and ‘.’)
Feature→Invoice-data is from a string with text written as 3224323432 (i.e., contains integer data)

The annotation system 210 allows a user (e.g., data scientist) to review random samples of documents from the ranked list of annotated documents 270 to find anomalies. Then, the user may update (i.e., refine) the annotations for maximum variability inherent in the data.

In certain embodiments, to predict the overall quality score 230, the annotation system 210 enables the quality threshold 232 to be configured (e.g., by a data scientist) for a given ML project. Then, if the overall quality score 230 is above the quality threshold 232, the review process is done, and the annotation system 210 trains the extraction ML model 280. If the extraction ML model 280 doesn't provide a desired output (e.g., based on the data scientist's feedback), then the quality threshold 232 may be adjusted.

In certain embodiments, if the overall quality score 230 is lower than or equal to the quality threshold 232, then the annotation system 210 provides the ranked list of annotated documents 270 for review and enables continuous feedback to improve the overall quality score 230 based on updated annotations.

Merely to enhance understanding of embodiments of the invention, examples will be provided herein. The annotation system 210 may display the example screens in the user interface 240. In certain embodiments, the samples in the examples are documents.

Initially, a user annotates the documents 260. In this example, there are a total number of annotated documents=q. From q documents, there are:
Training dataset: n=q−t
Testing dataset: q−T
Validation dataset: u=q−v

In certain embodiments, the annotation system 210 works with the datasets n, p, u, and the main dataset q. The annotations are added to field labels that are defined in an ontology (which is performed once). In this example, t is the total number of training dataset documents subtracted from the annotated documents; T is the total number of test documents subtracted from the annotated documents; and v is the total number of validation dataset documents subtracted from annotated documents.

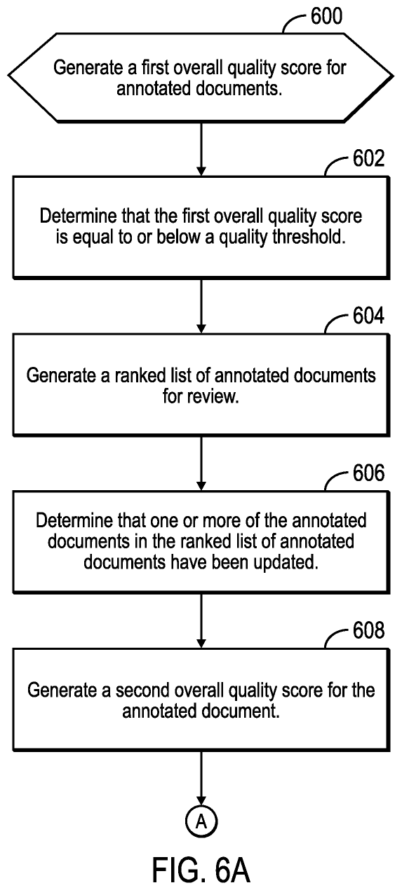

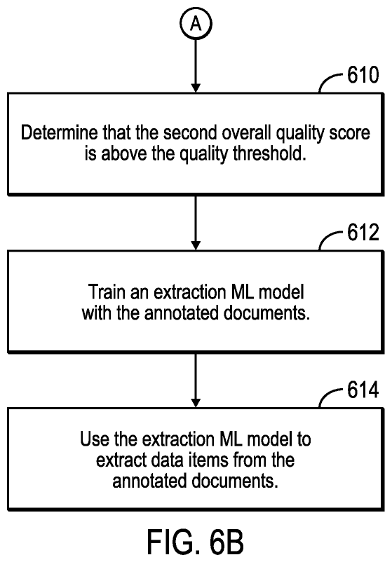

FIGS. 6A and 6B illustrate, in a flowchart, operations for training and using an extraction machine learning model based on predicting annotation quality in accordance with certain embodiments. Control begins at block 600 with the annotation system 210 generating a first overall quality score for annotated documents. In block 602, the annotation system 210 determines that the first overall quality score is equal to or below a quality threshold. In block 604, the annotation system 210 generates a ranked list of annotated documents for review. In block 606, the annotation system 210 determines that one or more of the annotated documents in the ranked list of annotated documents have been updated. In block 608, the annotation system 210 generates a second overall quality score for the annotated documents. Processing continues from block 608 (FIG. 6A) to block 610 (FIG. 6B).

In block 610, the annotation system 210 determines that the second overall quality score is above the quality threshold. In block 612, the annotation system 210 trains an extraction machine learning model with the annotated documents. In block 614, the annotation system 210 uses the extraction machine learning model to extract data items from the annotated documents. In certain embodiments, the data items are values of fields, along with the field labels, in the annotated documents.

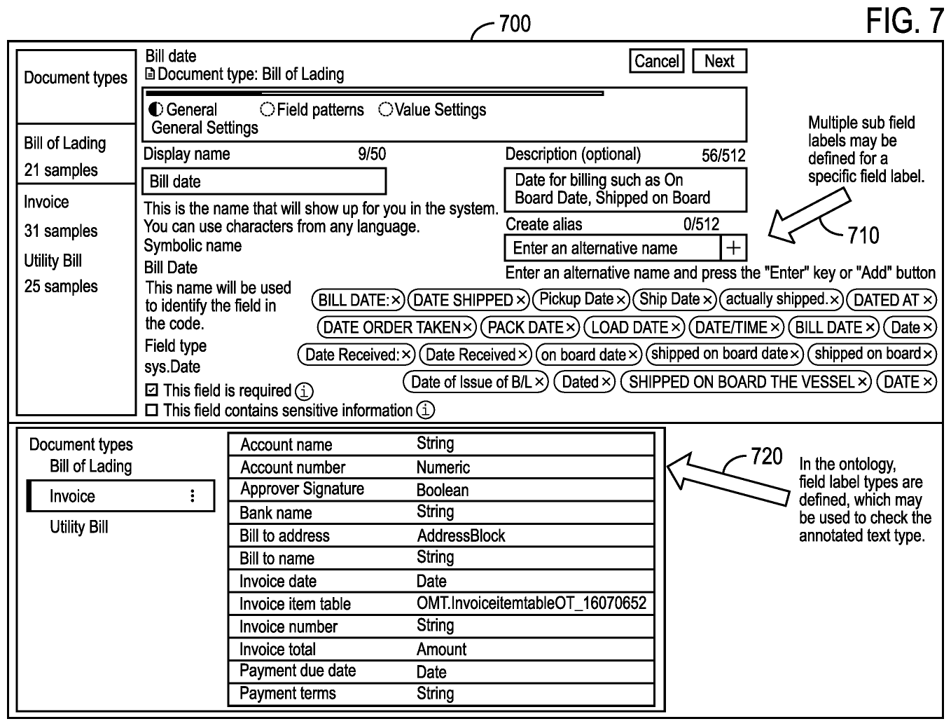

FIG. 7 illustrates an example screen 700 for defining field labels in an ontology in accordance with certain embodiments. In the screen 700, the annotation system 210 receives, for a Bill of Lading, input from a user to define multiple sub labels for a specific field label of “Bill date” in area 710. In addition, the annotation system 210 receives, for an Invoice, input from the user to define a field label type (e.g., string, numeric, etc.) for each field label (e.g., “Account name”, Account number”, etc.) in area 720.

In certain embodiments, the annotation system 210 uses a base score technique to generate a confidence score (i.e., a quality score) of annotations. The base quality score focuses on position and area of each annotated field label. Suppose the ontology has m field labels and each field label is annotated in each of the q documents, the field label may be identified using field type, character length, and location for every document class. In certain embodiments, the field type, character length, and location are provided when creating the field label.

In certain embodiments, the base quality score focuses on identifying annotations that are anomalies based on the position of fields.

In certain embodiments, each document has a single page. In certain other embodiments, each document may have one or more pages. For an annotated field label called “Invoice Number”, the field label “Invoice Number” has string field type (e.g., an alphanumeric field type) in each document.

The annotation system 210 specifies the pre-conditions that focus on the field label position in each document as follows:
Around n−k=k_docs documents have the field label “Invoice Number”. In this example, ‘j’ of the k documents k_docs/j have the field label “Invoice Number” positioned on the right hand side, with the partition as follows:
The partition of k_docs documents (with the field label on the right hand side)=>k_docs_parts=[k_docs−(k_docs/j)]/(k_docs/j)

The remaining documents from k_docs=k_docs_remain documents have the field label “Invoice Number” positioned on left hand side, with the partition as follows:
The partition of k_docs_remain documents (with field label on left hand side)=>k_docs_remain_parts=[k_docs_remain−(k_docs_remain/j)]/(k_docs_remain/j)

For each document with the annotated field “Invoice Number”, the annotation system 210 obtains the coordinates (x axis and y axis) for the annotated box. The annotated box may be described as the rectangular area of the annotation, which is a feature of the field label. Each annotated box provides a four-pointed position, with each position giving a location with x and y coordinates (consisting of the initial as well as the final position).

In this example, take a single point from the annotated position from the annotated box for field label “Invoice Number” to get coordinates x and y from n-k documents.

For each document's single annotated x axis position that satisfies the logical pre-conditions, the annotation system 210 creates multiple stacks for individual annotated field label position values. The annotation system 210 finds the average of the positional axis individually from the training dataset as follows:

X1 avg=(X11+X12+ . . . +X1n)/total number of X1 locations
Let X1 avg be 50%

Y1 avg=(Y11+Y12+ . . . +Y1n)/total number of Y1 locations

Let Y1 avg be 50%

In certain embodiments [X11+X12+ . . . +X1n] and [Y11+Y12+ . . . +Y1n] are in increasing order so that the annotation system 210 may use X1n of higher order in further calculations.

The annotation system 210 finds the percentage of positional axis (in each testing dataset ‘p’ documents) as follows:

X1 pos %=[|X11−X1 avg|/X1n]*100
where X11 is an axis coordinate from one of the document of ‘p’ Testing dataset=p1

Y1 pos %=[|Y11−Y1 avg|/Y1n]*100
where Y11 is an axis coordinate from one of the document of ‘p’ Testing dataset=p1

The annotation system 210 applies the above calculations if X11 is less than X1n, otherwise the condition will not be satisfied. That is, the condition is that the annotated field position ‘X’ minimum should be less than ‘X’ maximum to apply the X1 pos % and Y1 pos % calculations.

Similarly, the annotation system 210 finds out the average and percentage of positional axis for X2 and Y2.

Using the positional average values for X1, Y1, X2, Y2, the annotation system 210 finds the average values for each annotated field label as follows:

Each field label average percentage=(X1 pos %+X2 pos %+Y1 pos %+Y2 pos %)/4

Note, each field label average percentage is divided by 4 because the bounding box has a four-pointed position.

After finding the average from the positional axis, the annotation system 210 also considers the area of an annotated value confidence.

In certain embodiments, generic pre-conditions are ones that check whether the position of the annotated box is less than a maximum page position or not, so that if any position is greater than the maximum page position, there is an issue regarding that annotated box. With generic pre-conditions satisfied, the annotation system 210 finds the average value area as follows:
Area of an annotated value in a document (in the Training dataset) is:

AAVD→√(x2−x1)\hat{ }2+(y2−y1)\hat{ }2
Average Value Area=[AAVD1+AAVD2+ . . . AAVD(n−k)]/n−k

The annotation system 210 finds the percentage of each annotated value for each document as follows:

Percentage of annotated values=[(Value Area−Average Value Area)/AAVD(n−k)]*100
where, “Value Area” for Field label→“Invoice Number” is from p1 document in the Testing dataset (p)

The annotation system 210 applies the above calculations if the “Value Area” is always less than AAVD(n−k), otherwise, the above calculations for percentage of annotated values is not performed.

In addition, the annotation system 210 finds the page score confidence (i.e., an overall average from the annotated labels that share an overall page score confidence), finds the document score confidence using the page score confidence, and finds the base score using the document score confidence as follows:

Page Score Confidence (PSC)=(Field label 1%+Field label 2%+ . . . Field label n %)/Number of field labels

For Each Document:

Document Score Confidence(DSC)=[(PSC_1%+ . . . PSC_PN %)/Number of Pages(PN)

Base Score:

[(DSC_1%+ . . . +DSC_DN %)/Number of Documents(DN)]*100

In certain embodiments, the base Score confidence may be calculated via formula mentioned above (e.g., “Page Score Confidence” (i.e., by page) or “Each field label average percentage” (i.e., by class).

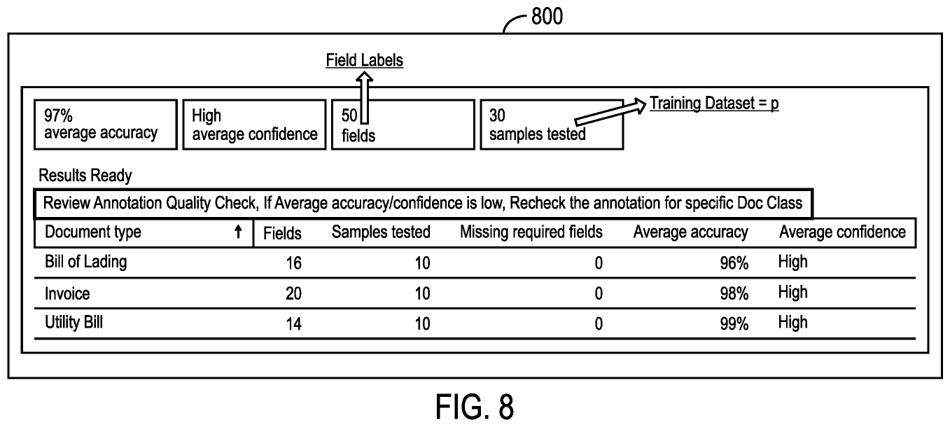

FIG. 8 illustrates an example annotation quality review summary 800 by document types for a base score technique in accordance with certain embodiments. In FIG. 8, the annotation system 210 has found high average accuracy and high average confidence for 50 field labels of 30 samples tested (i.e., documents) from a training dataset of p samples. If the annotation system 210 determines that the average accuracy and/or average confidence is low, the annotation system 210 may recommend rechecking the annotations for specific document classes.

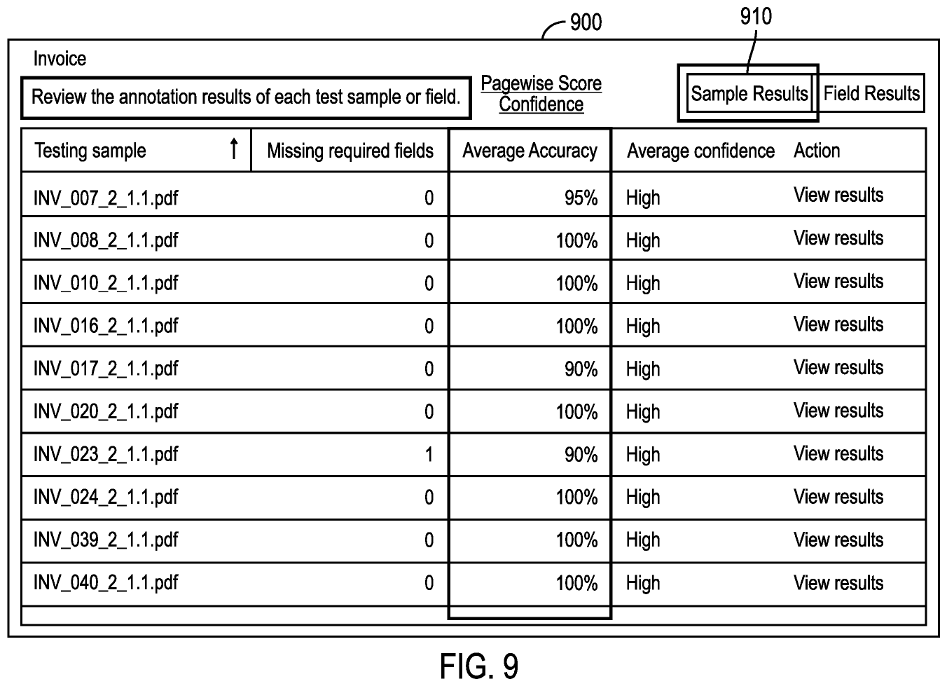

FIG. 9 illustrates an example annotation quality detail review summary 900 by documents for a base score technique in accordance with certain embodiments. In FIG. 9, Sample Results 910 has been selected, and the annotation system 210 provides, for each testing sample, an identifier of the testing sample, a number of missing required fields, an average accuracy (i.e., a page wise (i.e., per page) confidence score for accuracy of the testing sample), an average confidence of the testing sample, and actions. In response to user selection of an action (e.g., View results), the annotation system 210 provides additional information for the testing sample.

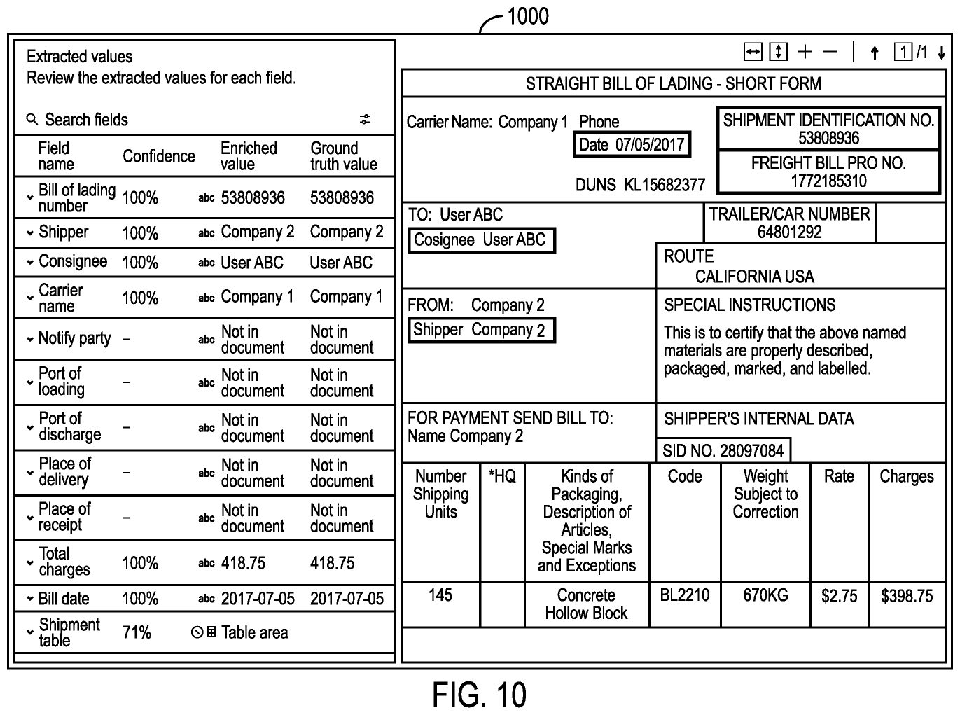

FIG. 10 illustrates an example annotation quality detail review summary 1000 by extracted values for a base score technique in accordance with certain embodiments. In FIG. 10, the annotation system 210 provides, for each field name, a confidence that the field name is correct for the page (i.e., a page score confidence when each testing sample has one page), an enriched value (i.e., an extracted value from the page), and a ground truth value (i.e., a known value used in a feature engineering model or input for validating the extraction ML model 280). In addition, the annotation system 210 provides a testing sample with certain fields highlighted (e.g., by having boxes around those fields) for ease of viewing the fields in the testing sample.

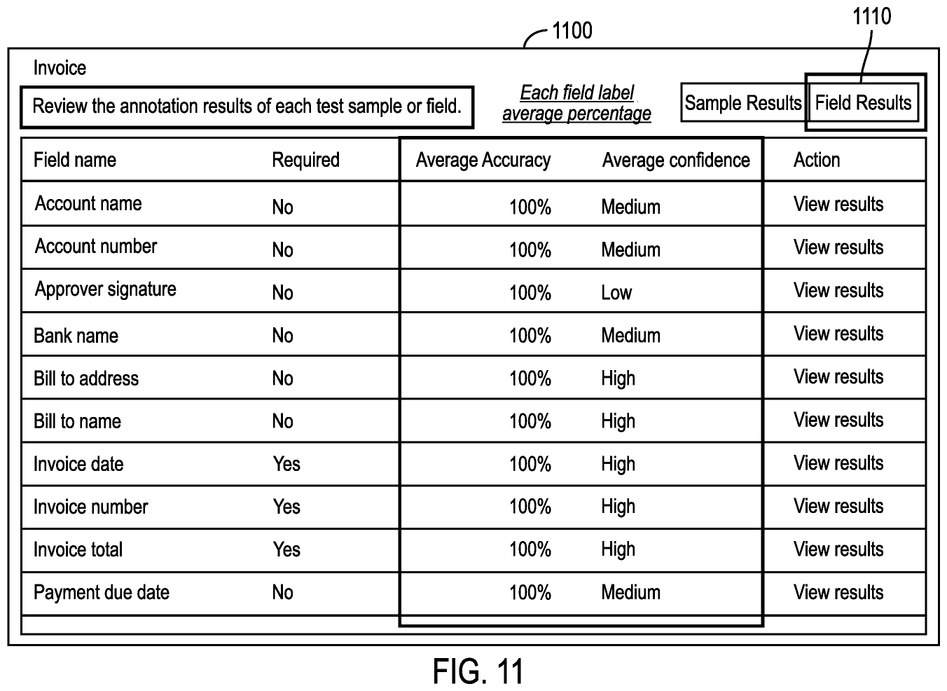

FIG. 11 illustrates an example annotation quality detail review summary 1100 by field names for a base score technique in accordance with certain embodiments. In FIG. 11, Field Results 1110 has been selected, and the annotation system 210 provides, by field name, whether that field is required, an average accuracy of the field name, an average confidence of the field name, and actions. In response to user selection of an action (e.g., View results), the annotation system 210 provides additional information for the field name.

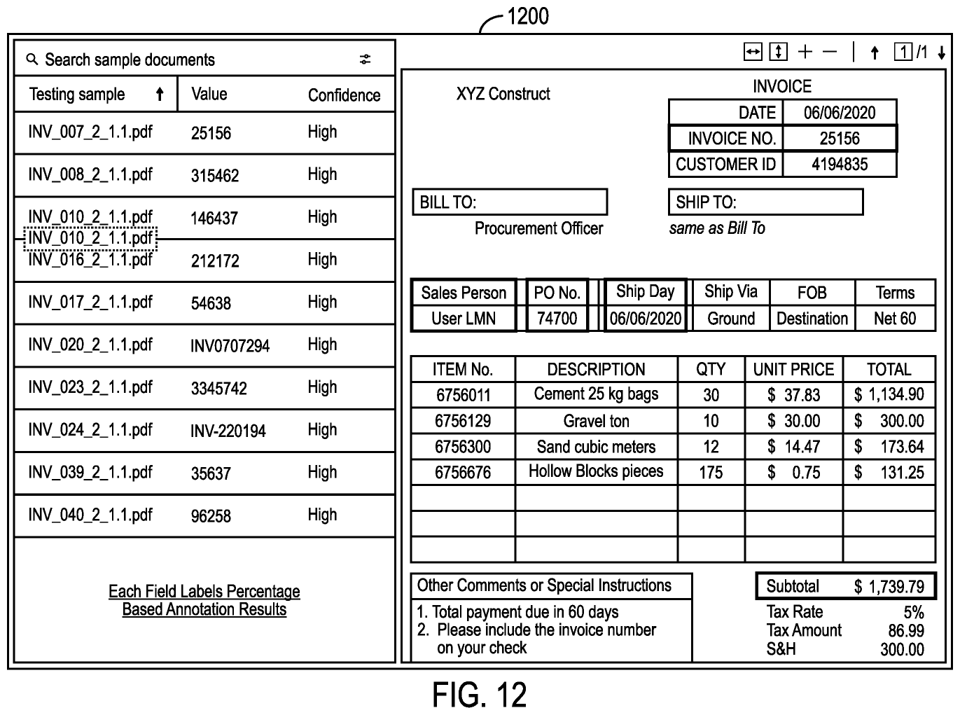

FIG. 12 illustrates an example annotation quality detail review summary 1200 with percentage based annotation results for test documents for a base score technique in accordance with certain embodiments. In FIG. 12, the annotation system 210 provides, by testing sample, a value of a field and a confidence that the value is correct. In addition, the annotation system 210 also provides a testing sample for each of viewing each value and the confidence of the testing sample. In FIG. 12, “Invoice Number” is a key, while “25156” is a value, and the combination of these is an example annotation.

In certain embodiments, the annotation system 210 uses a pattern technique to generate a confidence score (i.e., a quality score) of annotations.

In certain embodiments, the annotation system 210 uses the equations from the base score technique for the pattern technique and for the semantic analysis technique to determine confidence scores for each annotated document.

For example, suppose a user has multiple invoice documents, the annotation system 210 identifies a pattern of field in some of the annotated documents 262. The annotation system 210 determines that, while some annotated documents 262 have the same pattern of fields, other annotated documents 262 do not follow that pattern. The annotation system 210 enables the user to review the annotations of annotated documents 262 having the same pattern or annotated documents 262 that do not have that pattern. The patterns may also be referred to as a structures or formats.

If a user has corrected pre-annotated data of multiple documents with different patterns for every individual document, then the annotation system 210 enables the user to detect: whether there are any accidental errors, whether there are anomalies in similar patterns are found in multiple documents, and whether non-similarities between the positions of fields of the annotated documents having similar patterns are available in the pre-annotated dataset.

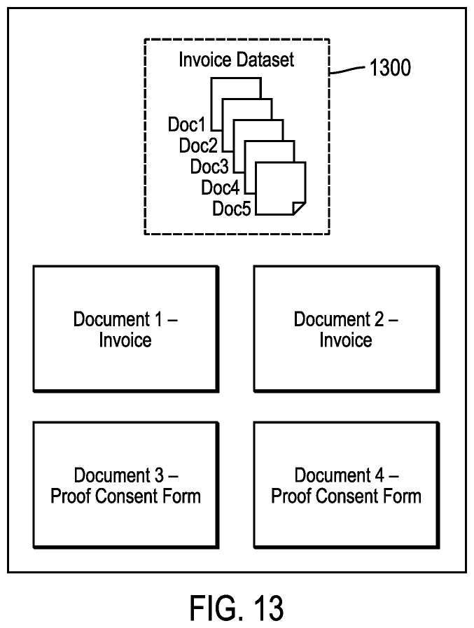

FIG. 13 illustrates an example of documents with different patterns in accordance with certain embodiments. In FIG. 13, an invoice dataset 1300 includes documents 1-5. In this example, documents 1 and 2 are invoices and have a similar pattern. Continuing with this example, documents 3 and 4 are proof of consent forms and have a similar pattern to each other (but a different pattern from documents 1 and 2).

For the pattern technique, suppose there is an existing dataset of ‘n-k’ documents that are correctly pre-annotated. In this example, these documents have patterns that are individually different from each other. For each document, the default range for a position (which may be customized by the user) is set for each annotation field label that shares the possibility of the position of the label annotated in the annotated document. For example, the dataset consists of annotations with field label names Invoice and Date, which are mostly on the right hand side of the annotated document's page. From these annotations, the annotation system 210 finds the average area, which provides the possible position of the field label annotated in the annotated document.

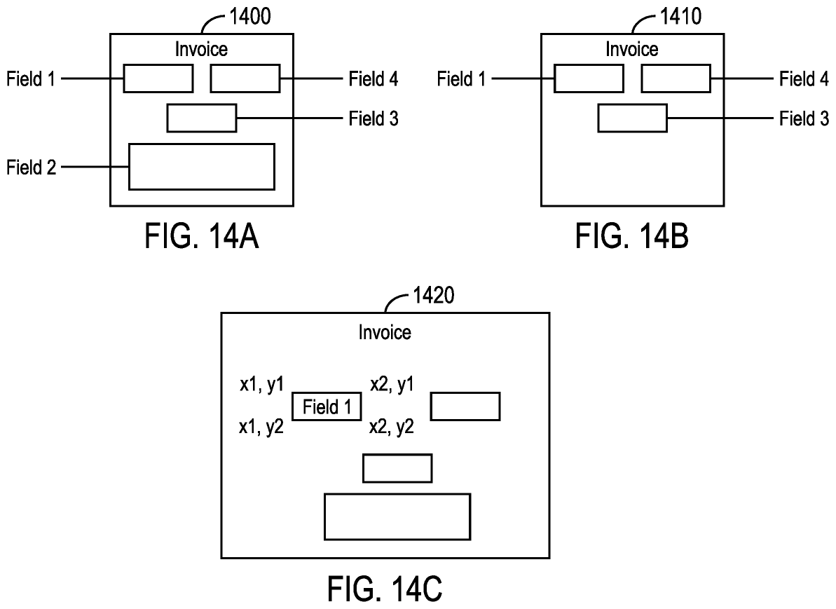

FIGS. 14A, 14B, and 14C illustrate various annotated documents with fields in accordance with certain embodiments. FIG. 14A illustrates an annotated document 1400 with annotated fields (Field 1, Field 2, Field 3, and Field 4), and each of these annotated fields may have a default range for the position.

Suppose there are ‘N’ (>100) annotated documents (e.g., newly annotated). A first set of documents from the ‘N’ annotated documents (e.g., 10% of the ‘N’ annotated documents) have a first pattern, while a second set of documents from the ‘N’ annotated documents have a second pattern (different from the first pattern for the first set of documents).

FIG. 14B illustrates a new annotated document 1410 from the ‘N’ documents that is similar to document 1400 (FIG. 14B), with Field 1, Field 3, and Field 4 (and without Field 2). That is, there is a match of 3 fields.

Once the pattern is identified with the three matching fields, the annotation system 210 determines the confidence score for a new document with a similar pattern. In particular, during annotation, the annotation system 210 identifies the position of each field label using the coordinates of top-left (x1,y1), top-right (x2,y1), bottom-left (x1,y2), and bottom-right corners (x2,y2). FIG. 14C illustrates an annotated document 1420 with a field label.

Once confidence scores are generated for the similar documents (where the scores are within the default range or higher), the annotation system 210 adds the confidence scores consecutively to generate overall average scores of each annotated labelled position in the annotated document.

For example, with the Default Range Score in Percentage (DRSP) for each annotated label, for anew document:
i % score for field label 1
Field 1 Score next document=(DRSP+1%)/2
j % score for field label 2
Field 2 Score next document=(DRSP+j %)/2
etc.

The annotation system 210 provides the confidence score output for each field label in increasing order to enable the user to check the ranked list of annotated documents 270 and identify any anomaly that should be annotated again. For example, with reference to field 1 that is included in document 1 and document 2, the annotation system 210 may provide the field label 1 score of 55%, with document 1 having a confidence score of 22% and document 2 having a confidence score of 34%.

In certain embodiments, the annotation system 210 determines that a set of documents has a lower confidence score with reference to a pattern and uses an average confidence score of the pattern with a voting technique to find a pattern-based anomaly.

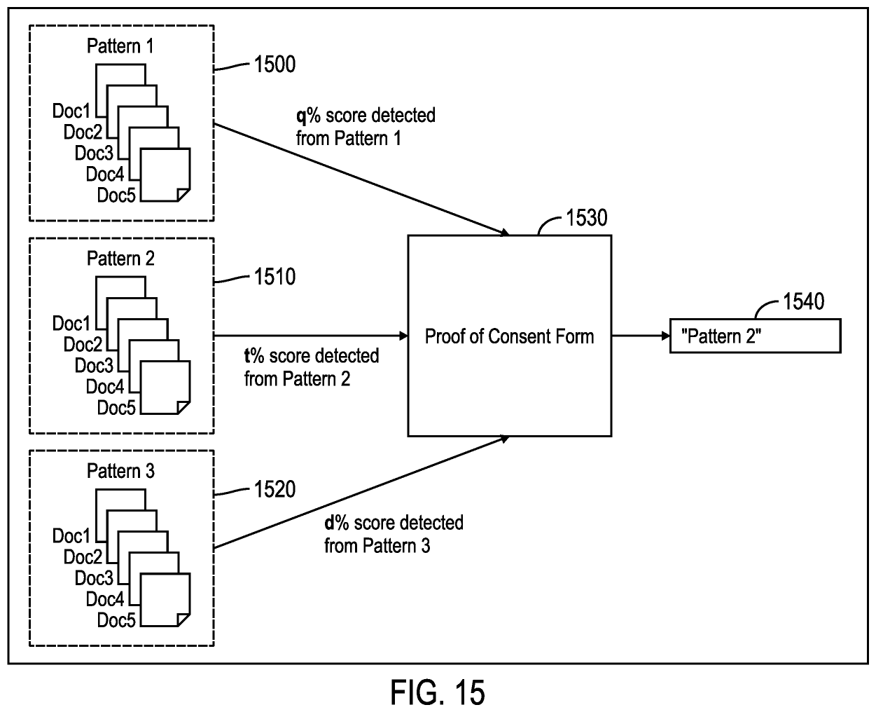

FIG. 15 illustrates an average confidence and voting technique in accordance with certain embodiments. In FIG. 15, a first set of documents 1500 has pattern 1, a second set of documents 1510 has pattern 2, and a third set of documents 1520 has pattern 3. A new proof of consent form 1530 is received, and the annotation system 210 determines q % confidence score for pattern 1, 1% confidence score for pattern 2, and d % confidence score for pattern 3. In this example, pattern 2 has the maximum labelled fields for the new proof of consent form 1530. In this example, using a voting technique, the annotation system 210 finds the average confidence of the pattern. In certain embodiments, the annotation system 210 also considers the outliers based on taking the inter quartile range reference from pattern 2 as an anomaly.

In certain embodiments, the annotation system 210 uses a semantic analysis technique to generate a quality score of annotations.

For training a model, multiple, annotated documents 262 belong to different document classes. Example document classes include: invoice, proof consent form, bill of lading, phone bill, utility bill, etc.

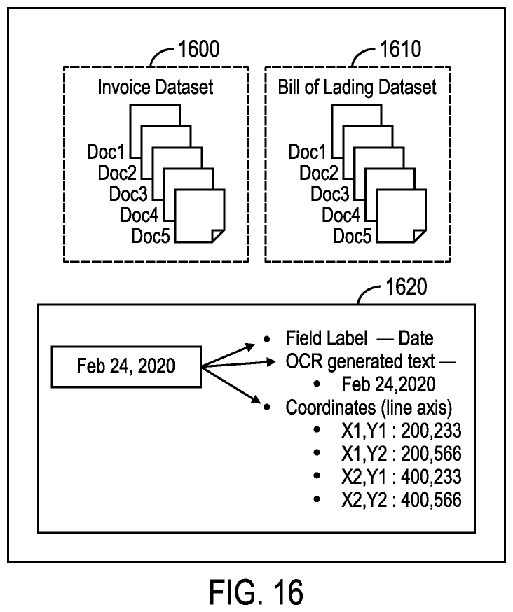

FIG. 16 illustrates datasets and field label information in accordance with certain embodiments. In FIG. 16 a first dataset 1600 has invoices and a second dataset 1610 has bills of lading. During annotation for an automatic document processing model, for each annotated field label in an annotated document, the annotation system 210 identifies the coordinates of bounding boxes around the annotated field labels. In certain embodiments, the annotation system 210 also identifies the text for each annotated field label (e.g., from an Optical Character Recognition (OCR) model). For example, in FIG. 16, in box 1620, for the date field, the annotation system 210 identifies the field label as “Date”, obtains the OCR generated text of “Feb. 24, 2020”, and identifies the coordinates.

With this information, the annotation system 210 enables a user to review a confidence score, how many documents are assigned to incorrect document classes, and how many types of Field type or annotated labels have been incorrectly annotated.

In certain embodiments, a user follows guidelines for adding annotations. The guidelines for the annotations are based on an existing ontology in which information related to a pre-annotated dataset describe:
1) Document Classes (e.g., invoice, proof consent form, bill of lading, phone bill, utility bill, etc.)
2) A dataset with existing fields, field types or labels used in annotation
3) OCR generated text for each pre-annotated dataset and annotated with field labels

This information helps in feature engineering model processing. Feature engineering models may be described as selecting, manipulating and transforming raw data into features that may be used in supervised learning.

In certain embodiments, a cross validation set (e.g., K-Fold Cross Validation) helps the annotation system 210 to compute an annotation quality score (backed by some computation).

In certain embodiments, the results of a statistic-based analysis generalize to an independent dataset (available in ontology) and help finding out which document class has a greater number of incorrect documents.

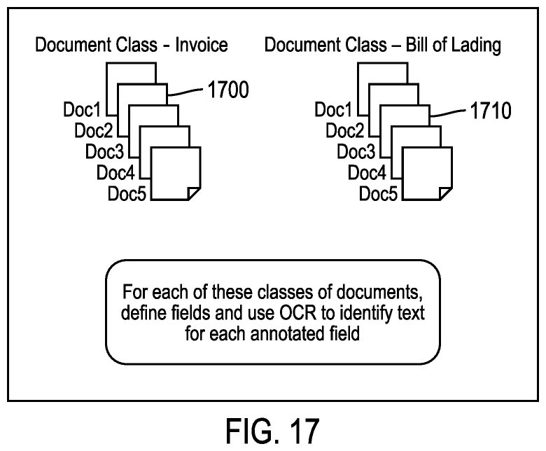

FIG. 17 illustrates ontology data for feature engineered models in accordance with certain embodiments. In FIG. 17, a first dataset 1700 is of document class invoice, while a second dataset 1710 is of document class bill of lading. For these classes of documents 1700, 1710, the annotation system 210 defines fields and uses OCR to identify text for each annotated field label.

In certain embodiments, the annotation system 210 uses feature engineered models (created from the pre-annotated text base information available in ontology) to detect the anomalies for the annotated labels. The annotation system 210 also provides information of the annotated documents in which detected anomalies are less than or equal to an annotation threshold 234 for user review.

In certain embodiments, the feature engineered models may be dependent on techniques such as: a Markov chain, vanilla Viterbi technique, a K search, vectors, etc. The feature engineered models use the ontology for creating the corpus and work with the techniques to extract the required text.

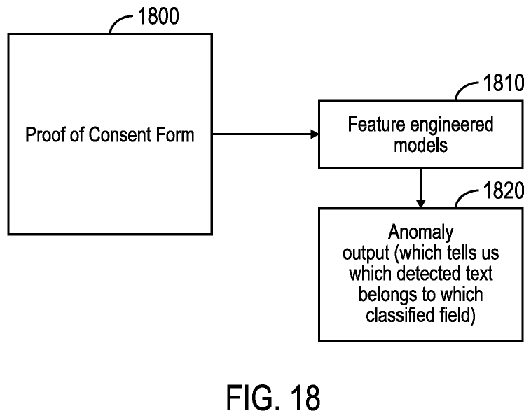

FIG. 18 illustrates processing by feature engineered models in accordance with certain embodiments. In block 1810, the feature engineered models receive a proof of consent form. In block 1820, the feature engineered models output an anomaly, which indicates which text belongs to which class of field.

In certain embodiments, a feature engineered model receives as input the text of an annotated document and outputs a confidence score for the input text, where the input text belongs to a field label.

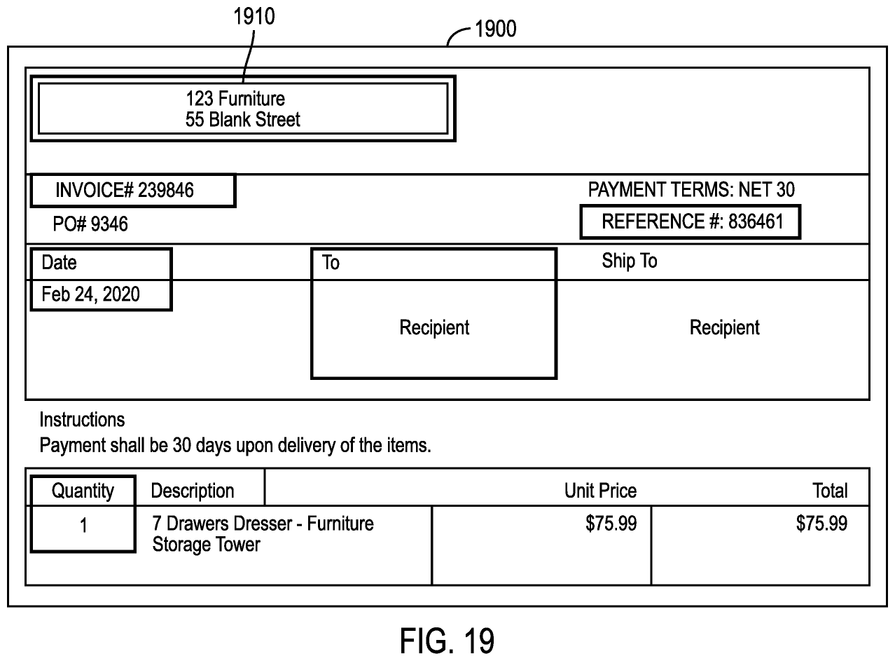

FIG. 19 illustrates an example review for document anomalies in accordance with certain embodiments. In FIG. 19, the annotation system 210 provides a form 1900 with anomalies highlighted that are to be reviewed. In FIG. 19, the address field 1910 is highlighted for review.

In certain embodiments, fields containing values with a large standard deviation may result in more reviews. In certain embodiments, the dataset is a consistent dataset (rather than a high variance sample set).

With embodiments, as there may be multiple documents with different patterns, the annotation system 210 selects a set of documents that belong to the same document class for processing.

While adding more features or examples in any of the techniques, embodiments focus on being precise and using the recall function properly so that the process is not overfitted. That is, as the dataset for the feature engineering model increases, variance may also increase. To overcome this issue of increased variance, embodiments are to be precise while creating the feature engineered model.

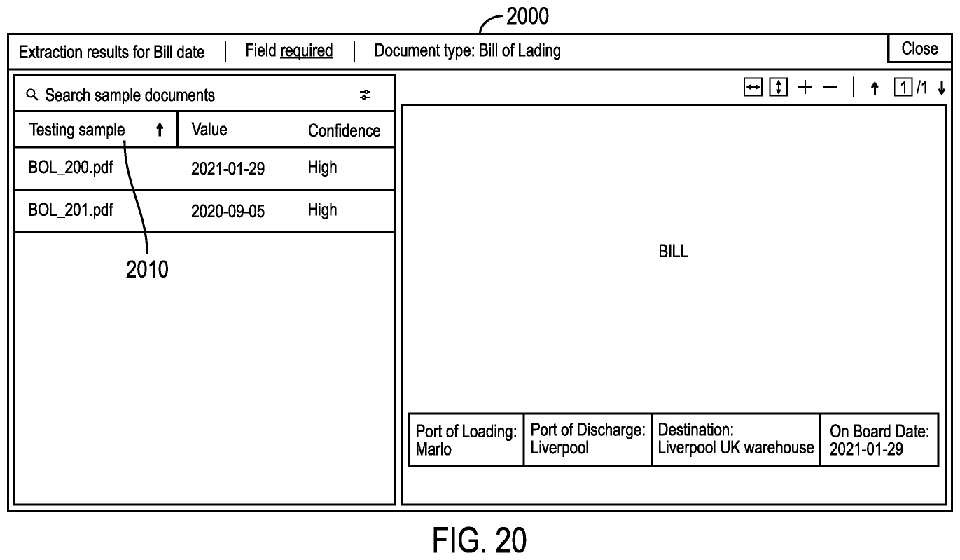

FIG. 20 illustrates an example screen 2000 for annotation review in accordance with certain embodiments. In FIG. 20, the annotation system 210 provides the example screen with extraction results for “Bill date”. In the example screen 2000, a table includes, for each testing sample 2010, a value and a confidence, along with a testing sample.

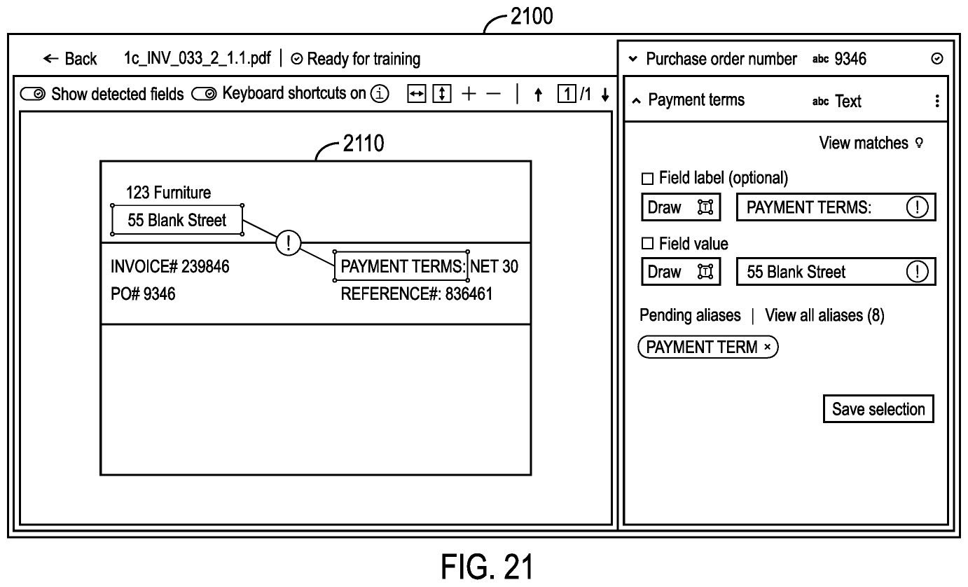

FIG. 21 illustrates an example screen 2100 for error analysis in accordance with certain embodiments. In FIG. 21, the annotation system 210 indicates that “PAYMENT TERMS” is an incorrect annotation for the address in area 2110.

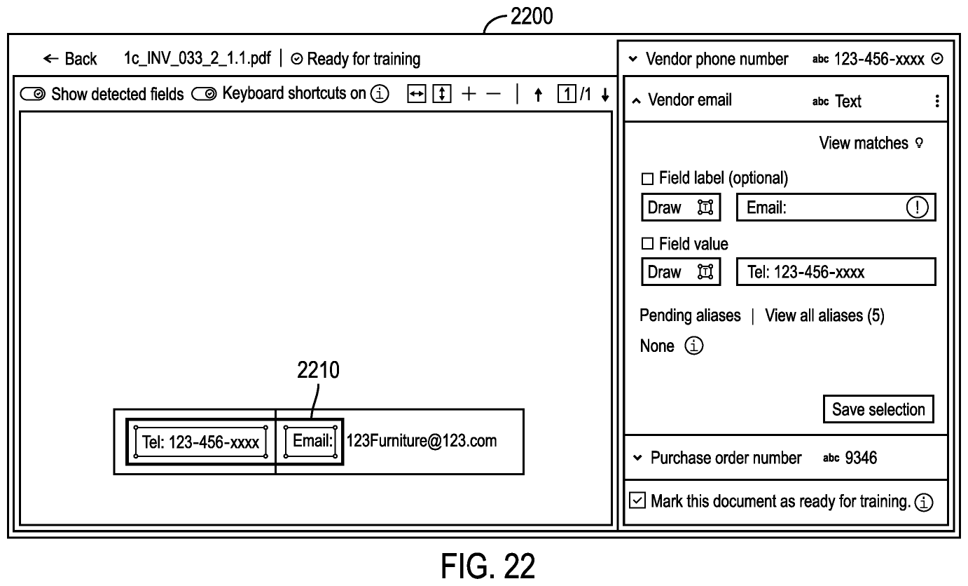

FIG. 22 illustrates an example screen 2200 of an anomaly in accordance with certain embodiments. In FIG. 22, the annotation system 210 is able to detect the anomaly where “Email” is a key, and “Telephone” is the value in area 2210.

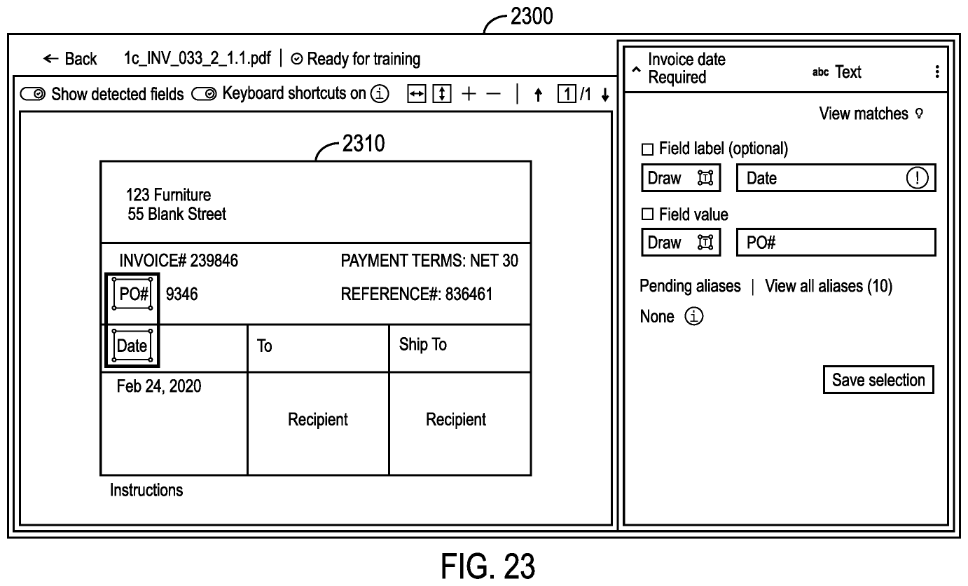

FIG. 23 illustrates an example screen 2300 of another anomaly in accordance with certain embodiments. In FIG. 23, the annotation system 210 is able to detect the anomaly where “Date” is the key, and “PO #” is the value in area 2310.

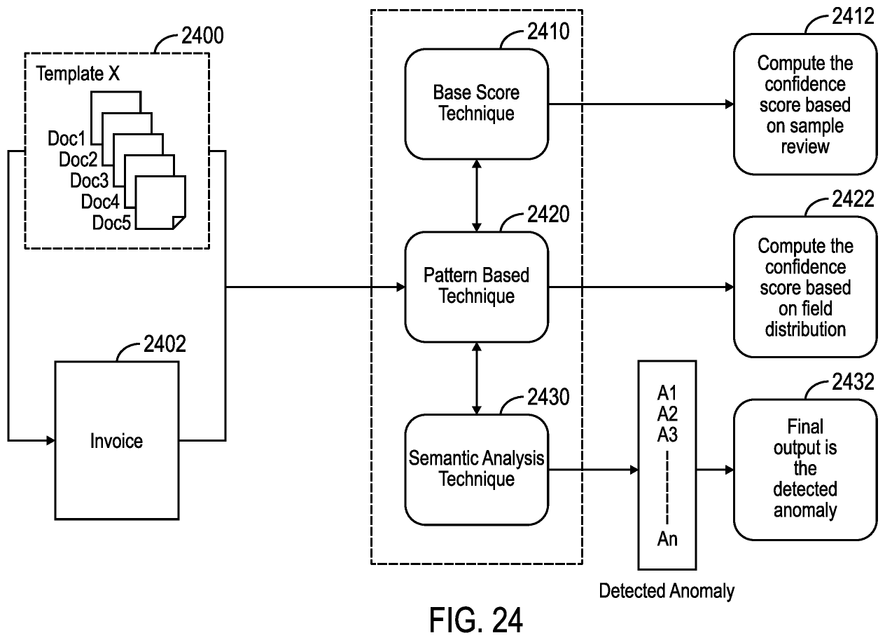

FIG. 24 illustrates processing of a dataset in accordance with certain embodiments. In FIG. 24, a dataset 2400 includes documents, such as an invoice 2402. In block 2410, the base score technique processes the dataset 2400 and, in block 2412, computes the confidence score based on sample review. In block 2420, the pattern technique processes the dataset 2400 and, in block 2422, computes the confidence score based on field distribution. In block 2430, the semantic analysis technique processes the dataset 2400 and, in block 2432, outputs a detected anomaly.

In certain embodiments, once the documents 260 are annotated, the annotation system 210 computes an overall quality score 230 (e.g., an overall quality annotation confidence score). The annotation system 210 performs analysis of field types used as labels in the annotations and finds a confidence and insights score for each field using semantic analysis techniques. The annotation system 210 computes an anomaly pattern (e.g., for human accidental errors) in the annotations using a pattern technique. The annotation system 210 produces a ranked list of the annotated documents 270 for review.

The annotation system 210 provides an optimized technique for a second level review. In addition, the annotation system 210 provides improved annotations for the annotated documents 262 from a feedback loop, which allows for an optimized annotation review for the annotated documents 262 and runtime corrected document annotations.

In certain embodiments, the annotation system 210 identifies semantic annotation errors using supervised learning, inadvertent human errors using clustering and Machine Learning (ML) based classifiers, and finds anomalies in the annotations using the pattern technique. In certain embodiments, the annotation system 210 outputs one or more ranked lists of annotated documents 270 on the annotated documents 262 and enables a user (e.g., a human user) to review a random sample of the annotated documents 262 to find the anomalies. In certain embodiments, the annotation system 210 also predicts the overall quality score 230 and provides for review a ranked list of annotated documents 270 and uses continuous feedback to improve the annotations on the annotated documents 262.

In certain embodiments, the annotation system 210 improves annotations by giving feedback to the user about the quality of the annotations. In addition, the annotation system 210 helps users improve the quality of the annotations, which in turn advances the extraction accuracy of the extraction ML model 280.

In certain embodiments, the annotation system 210 computes the quality score 230 for the annotations before training the extraction ML model 280 by using random sampling (e.g., for semantic errors), clustering (e.g., for field errors), and a pattern technique (i.e., anomaly pattern detection). With embodiments, instead of reviewing the annotated documents 262 to verify the quality of the annotations, the annotation system 210 computes the overall quality score of the annotations. In certain embodiments, if the overall quality score is higher than a quality threshold, the annotations are not separately verified by the user.

In certain embodiments, for a large dataset (e.g., containing 10,000 annotated documents), the annotation system 210 identifies a random sample of annotated documents (e.g., 100) and reviews the annotations in the random sample. The annotation system 210 computes a quality annotation score for the random sample. The annotation system 210 computes a quality annotation score for the entire dataset (e.g., containing 10,000 annotated documents) based on the sample review.

In certain embodiments, cluster analysis groups documents with related annotations together. For example, Invoice Number, Invoice Date, Send To, and Bill To annotated documents are in one cluster, while Total, Subtotal, and Payment Due are in another cluster.

In certain embodiments, the annotation system 210 focuses on improving the quality of annotations by detecting the low quality scored and/or missing annotations to be reviewed and updated, so that the extraction ML model 280 may be trained with better annotations. In certain embodiments, the annotation system 210 works with structured documents, semi-structured documents, and unstructured data.

In certain embodiments, the pre-annotated dataset uses an ontology based on the key value pairs in the dataset, and the annotation system 210 tests and validates inaccurate labels as per document class specific by using a static technique and feature engineering techniques. In certain embodiments, to predict the annotation quality score, the annotation system 210 is leveraging the following features from the annotations:
Positional—coordinates based static average score of series, ML classifiers.
Patterns—dependency to build confidence using positional average for annotated dataset with reference to a specific annotation threshold.
Semantics—dependency to use position alone or both position and patterns with reference to a specific annotation threshold and to use corpus, rule-based techniques as well as feature engineering techniques to extract the correct or partially correct key value pairs from block-based text or running text in documents.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
generating a first overall quality score for annotated documents;
determining that the first overall quality score is below a quality threshold;
generating a ranked list of annotated documents for review;
determining that one or more of the annotated documents in the ranked list of annotated documents have been updated;
generating a second overall quality score for the annotated documents;
determining that the second overall quality score is above the quality threshold;
training an extraction machine learning model with the annotated documents; and
using the extraction machine learning model to extract data items from the annotated documents.

2. The computer-implemented method of claim 1, further comprising operations for:
performing a technique selected from a group of techniques comprising a base score technique, a pattern technique, and a semantic analysis technique.

3. The computer-implemented method of claim 2, wherein the base score technique generates the ranked list of annotated documents based on confidence scores of positions of fields in the annotated documents.

4. The computer-implemented method of claim 2, wherein the pattern technique generates the ranked list of annotated documents based on confidence scores of pattern of fields in the annotated documents.

5. The computer-implemented method of claim 2, wherein the semantic analysis technique generates the ranked list of annotated documents based on confidence scores of semantic analysis of fields in the annotated documents.

6. The computer-implemented method of claim 1, further comprising operations for:
receiving a search request that refers to a model quality measure; and
returning one or more of the annotated documents that match the model quality measure.

7. The computer-implemented method of claim 1, further comprising operations for:
receiving updated, annotated documents; and
fine tuning the extraction machine learning model with the updated, annotated documents based on a new overall quality score exceeding the quality threshold.

8. A computer program product, the computer program product comprising a computer readable storage medium having program instructions embodied therewith, the program instructions executable by a processor to cause the processor to perform operations for:
generating a first overall quality score for annotated documents;
determining that the first overall quality score is below a quality threshold;
generating a ranked list of annotated documents for review;
determining that one or more of the annotated documents in the ranked list of annotated documents have been updated;
generating a second overall quality score for the annotated documents;
determining that the second overall quality score is above the quality threshold;
training an extraction machine learning model with the annotated documents; and
using the extraction machine learning model to extract data items from the annotated documents.

9. The computer program product of claim 8, wherein the program instructions are executable by the processor to cause the processor to perform further operations for:
performing a technique selected from a group of techniques comprising a base score technique, a pattern technique, and a semantic analysis technique.

10. The computer program product of claim 9, wherein the base score technique generates the ranked list of annotated documents based on confidence scores of positions of fields in the annotated documents.

11. The computer program product of claim 9, wherein the pattern technique generates the ranked list of annotated documents based on confidence scores of pattern of fields in the annotated documents.

12. The computer program product of claim 9, wherein the semantic analysis technique generates the ranked list of annotated documents based on confidence scores of semantic analysis of fields in the annotated documents.

13. The computer program product of claim 8, wherein the program instructions are executable by the processor to cause the processor to perform further operations for:
receiving a search request that refers to a model quality measure; and
returning one or more of the annotated documents that match the model quality measure.

14. The computer program product of claim 8, wherein the program instructions are executable by the processor to cause the processor to perform further operations for:
receiving updated, annotated documents; and
fine tuning the extraction machine learning model with the updated, annotated documents based on a new overall quality score exceeding the quality threshold.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
generating a first overall quality score for annotated documents;
determining that the first overall quality score is below a quality threshold;
generating a ranked list of annotated documents for review;
determining that one or more of the annotated documents in the ranked list of annotated documents have been updated;
generating a second overall quality score for the annotated documents;
determining that the second overall quality score is above the quality threshold;
training an extraction machine learning model with the annotated documents; and
using the extraction machine learning model to extract data items from the annotated documents.

16. The computer system of claim 15, wherein the program instructions perform further operations comprising:
performing a technique selected from a group of techniques comprising a base score technique, a pattern technique, and a semantic analysis technique.

17. The computer system of claim 16, wherein the base score technique generates the ranked list of annotated documents based on confidence scores of positions of fields in the annotated documents.

18. The computer system of claim 16, wherein the pattern technique generates the ranked list of annotated documents based on confidence scores of pattern of fields in the annotated documents.

19. The computer system of claim 16, wherein the semantic analysis technique generates the ranked list of annotated documents based on confidence scores of semantic analysis of fields in the annotated documents.

20. The computer system of claim 15, wherein the program instructions perform further operations comprising:
receiving a search request that refers to a model quality measure; and
returning one or more of the annotated documents that match the model quality measure.
